(19) United States
(12) Patent Application Publication
(10) Pub. No.: US 2014/0083723 A1
(43) Pub. Date: Mar. 27, 2014

(54) FAULT-TOLERANT FIRE PROTECTION SYSTEM

(71) Applicant: Niels Erik Danielsen, Brabrand (DK)

(72) Inventor: Niels Erik Danielsen, Brabrand (DK)

(73) Assignee: VESTAS WIND SYSTEMS A/S, Aarhus N (DK)

(21) Appl. No.: 14/008,462

(22) PCT Filed: Mar. 16, 2012
(86) PCT No.: PCT/DK2012/050078

§ 371 Date: Dec. 4, 2013

(30) Foreign Application Priority Data
Mar. 30, 2011 (DK) PA 2011 70145

(51) Int. Cl. A62C 2/00

(52) U.S. Cl. CPC A62C 2/00
USPC 169/45; 169/60

(57) ABSTRACT

The present invention relates to a redundant fire protection system for a wind turbine adapted to feed power into an associated power supply grid, the redundant fire protection system comprising a fire protection control unit, a first group of fire protection related detectors adapted to monitor a first wind turbine component, and a second group of fire protection related detectors adapted to monitor the first wind turbine component, wherein the fire protection control unit is operatively connected to the first and second groups of fire protection related detectors via a redundant power supply and data communication network. The present invention further relates to a wind turbine applying such a redundant fire protection system, and an associated method.

### FIELD OF THE INVENTION

The present invention relates to a fault-tolerant fire protection system for wind turbines. In particular, the present invention relates to a fault-tolerant fire, smoke and over/leak current protection system.

### BACKGROUND OF THE INVENTION

Protection systems in wind turbines of today typically involve tripping of a circuit breaker. Such tripping of the circuit breaker may be divided into two groups—namely:
1) Active trip of high voltage (HV) circuit breaker.
2) Passive fail-safe trip of HV circuit breaker.

### Active Trip of HV Circuit Breaker

A system suitable for active tripping applies a trip solenoid in a switch gear. The trip solenoid requires energy in order to trip. During normal working conditions energy is supplied to the trip solenoid from the associated power supply grid. If the power supply grid fails or somehow collapses, the system needs an alternative energy source in order to trip the switch gear. This alternative energy source has not proved to be reliable. In conclusion, these systems can have dormant faults resulting in loss of protection and consequently turbine fire.

### Passive Fail-Safe Trip of HV Circuit Breaker

This system applies a trip solenoid that has to be energized in order to keep the switch gear connected. This system is generally safe, but any single fault, even a 1 second interruption of the power supply, will trip the switch gear. Inspection of the wind turbine is required before the wind turbine is started again.

It may be seen as an object of embodiments of the present invention to provide a fault-tolerant fire protection system which is capable of maintaining the wind turbine in production even if a single fault occurs.

### DESCRIPTION OF THE INVENTION

The above-mentioned object is complied with by providing, in a first aspect, a redundant fire protection system for a wind turbine adapted to feed power into an associated power supply grid, the redundant fire protection system comprising
a fire protection control unit,
a first group of fire protection related detectors adapted to monitor a first wind turbine component, and
a second group of fire protection related detectors adapted to monitor the first wind turbine component,
   wherein the fire protection control unit is operatively connected to the first and second groups of fire protection related detectors via a redundant power supply and data communication network.

Thus, according to the present invention selected wind turbine components are each monitored by a plurality of detectors. To increase the reliability of the fire protection system additional groups of fire protection related detectors may be provided.

The fire protection system according to the present invention offers the following benefits:
1) No single fault will result in loss of protection
2) A high degree of diagnostic coverage
3) No single fault will trip the switch gear and cause loss of production and forced inspection
4) A double fault in one type of components, e.g. dual controller fault, results in a safe trip.
5) A double fault in the power supply will cause the wind turbine to trip. However, if an auxiliary energy source is provided the switch gear can be reconnected remotely by means of for examples motors.

The fire protection control unit may comprise a first control module and a second control module. The first and the second control modules may be operatively connected to the first and second groups of fire protection related detectors, respectively.

The fire protection control unit may be operatively connected to a controllable switch gear arrangement. In this way, the fire protection control unit is capable of activating the controllable switch gear arrangement so as to disconnect the wind turbine from the associated power supply grid if demands so require. Such demands may include detected over currents, arcs, smoke or even fire in the wind turbine.

The fire protection control unit may be arranged to monitor the state of the controllable switch gear arrangement, and it may be arranged to prevent reconnection in case the wind turbine has been disconnected from the associated power supply grid and in case the switch gear monitoring indicates that it is not safe to reconnect. Such indications could include low SF6 gas pressure in case of gas insulated switch gear, grounding switch connected, or loss of arc protection.

Optionally, a fire suppression system capable of dispersing water, powder, foam, inert gasses or a combination thereof may be provided. In terms of implementation, the protection control unit may be operatively connected to a controllable fire suppression arrangement. In this way, the fire protection control unit is capable of activating suitable fire suppression agents if a fire is detected. The fire suppression arrangement may be activated upon detection of arcs, smoke or even fire in the wind turbine.

The first and second groups of fire protection related detectors may comprise one or more fire detectors, one or more smoke detectors, one or more arc detectors and/or one or more current detectors. Other types of detectors may be applicable as well.

The power supply network may have a redundant architecture comprising a first and a second power supply path. If one power supply path breaks downs power may be provided via the other power supply path. Similarly, the data communication network may have a redundant architecture comprising a first and a second communication path in order to increase the reliability of the system.

The redundant fire protection system may further comprise a redundant current detection arrangement being operatively connected to the fire protection control unit. Redundancy may be implemented by providing a first and a second current sensor. The first current sensor may be operatively connected to the first control module, whereas the second current sensor may be operatively connected to the second control module. Both the first and the second control module may be capable of tripping the switch gear so as to disconnect the wind turbine from the associated power supply grid if a current sensor signal so demands.

The redundant fire protection system may further comprise means for manually tripping the wind turbine.

In a second aspect, the present invention relates to a wind turbine comprising a redundant fire protection system according to the first aspect.

In a third aspect, the present invention relates to a method for protecting a wind turbine adapted to feed power into an associated power supply grid, the method comprising the steps of
providing a first group of fire protection related detectors for monitoring a first wind turbine component,
providing a second group of fire protection related detectors for monitoring the first wind turbine component, and
performing a predetermined protection act if a detector of the first and/or the second group of fire protection related detectors detects an abnormal working condition.

Thus, the predetermined protection act may be performed in response to a signal from more than one detector (Double-knock). The predetermined protection act may involve activation the fire protection. Alternatively or in combination therewith, the predetermined protection act may comprise the step of tripping a switch gear so as to disconnect the wind turbine from an associated power supply grid until normal working conditions is re-established.

### BRIEF DESCRIPTION OF THE DRAWING

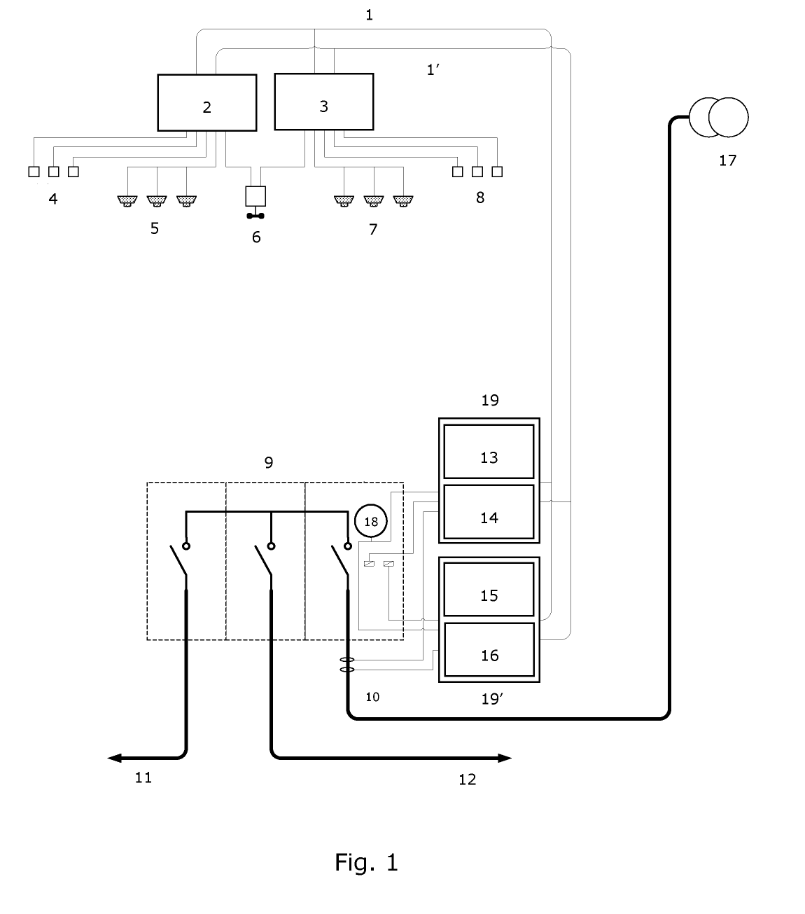

The present invention will now be explained in further details with reference to FIG. 1. While the invention is susceptible to various modifications and alternative forms, a specific embodiment has been shown by way of example in the drawing and will be described in detail herein. It should be understood, however, that the invention is not intended to be limited to the particular form disclosed. Rather, the invention is to cover all modifications, equivalents, and alternatives falling within the spirit and scope of the invention as defined by the appended claims.

### DETAILED DESCRIPTION OF THE INVENTION

In general, the present invention relates to a redundant fire protection system for wind turbines. According to the present invention a plurality of different types of detectors monitor selected components of a wind turbine. For example, a pair of independent smoke detectors monitors the gear box of a wind turbine. If smoke is detected by just one of the smoke detectors an alarm signal is communicated to a fire protection control unit which is capable of for example tripping the wind turbine by disconnecting it from an associated power supply grid. The fire protection control unit is capable of initiating other protection schemes as well.

FIG. 1 shows an embodiment of the present invention—this embodiment being configured as an arc and smoke protection system of a wind turbine. It should be noted that the present invention is however not limited to this kind of fire protection systems.

As depicted in FIG. 1 the redundant fire protection system comprises a fire protection control unit having two control modules 19, 19′. Each of the control modules 19, 19′ houses a fire safety control unit 13, 15, respectively, and a fire safety input/output data unit 14, 16, respectively. It should be noted that the two control modules 19, 19′ of the fire protection control unit may be integrated within separate controllers within the wind turbine, arranged for performing further control acts than fire protection.

Moreover, two independent groups of smoke detectors 5, 7 and two independent groups of arc detectors 4, 8 are operative connected to the controller 19, 19′ via a redundant data communication and power supply network 1, 1′ and via fire safety input/output data units 2, 3. In FIG. 1, the two groups of arc detectors 4, 8 each contains three arc detectors, and the two groups of smoke detectors 5, 7 each contains three arch detectors. However, any other appropriate number of arc and smoke detectors in each of the groups of detectors is conceivable. The redundant data communication and power supply network 1, 1′ is in FIG. 1 shown as a combined network where data is communicated on power supply lines 1, 1′. Obviously, data may alternatively be communication on data lines separate from the power supply lines. Thus, the various groups of detectors are connected to the two controllers 19, 19′ in a redundant manner so that each detector group is connected to each controller 19, 19′. If any of the detectors fails or if a controller fails, a replacement detector/controller is ready to take over the defective detector's/controller's task.

The system depicted in FIG. 1 further comprises:
1) Double current monitoring/measuring 10
2) Double data communication and power supply architecture between detectors and controllers 1, 1′
3) Manual trip button with double contact sets 6

Optionally, the system depicted in FIG. 1 may be supplemented by a fire extinguishing system.

Thus, the system depicted in FIG. 1 is a fully redundant fire protection system where independent groups of smoke detectors 5, 7 and independent groups of arc detectors 4,8 communicate with two independent fire protection controllers 19, 19′. Each fire protection controller 19, 19′ is capable of tripping a switch gear 9 whereby a high voltage transformer 17 of wind turbine is disconnected from the grid (not shown). Tripping is performed by activating a motor 18 of the switch gear.

Tripping of the switch gear typically occurs if smoke, fire, over currents or leak currents are detected. Over current and leak current protection is provided by monitoring the power line from the high voltage transformer 17. The switch gear can also be tripped manually by activating a manual trip button 6.

The combined data communication networks and the power supply networks 1, 1′ interconnecting the control modules 19, 19′ and the input/output units 2, 3 are arranged in a redundant manner by having at least two parallel data communication networks and at least two power supply networks. Thus, if one of the data communication networks fails, the other communication network takes over. Similarly, if one of the power supply networks fails, the other power supply network takes over.

Obviously, it lies within the scope of the present invention that additional and/or other types of fire protection related detectors may be included in the system. Also, additional data communication paths, control modules and/or power supply lines may be provided in order to increase the reliability of the system.

1. A redundant fire protection system for a wind turbine adapted to feed power into an associated power supply grid, the redundant fire protection system comprising
a fire protection control unit,
a first group of fire protection related detectors adapted to monitor a first wind turbine component, and
a second group of fire protection related detectors adapted to monitor the first wind turbine component,
wherein the fire protection control unit is operatively connected to the first and second groups of fire protection related detectors via a redundant power supply and data communication network.

2. A redundant fire protection system according to claim 1, wherein the fire protection control unit comprises a first control module and a second control module.

3. A redundant fire protection system according to claim 2, wherein the first and the second control modules are operatively connected to the first and second groups of fire protection related detectors, respectively.

4. A redundant fire protection system according to claim 1, wherein the fire protection control unit is operatively connected to a controllable switch gear arrangement.

5. A redundant fire protection system according to claim 4, wherein the fire protection control unit is adapted to activate the controllable switch gear arrangement so as to disconnect the wind turbine from the associated power supply grid if demands so require.

6. A redundant fire protection system according to claim 3, wherein the fire protection control unit is arranged to monitor the state of the controllable switch gear arrangement.

7. A redundant fire protection system according to claim 6, wherein the fire protection control unit is arranged to prevent reconnection in case the wind turbine has been disconnected from the associated power supply grid and in case the switch gear monitoring indicates that it is not safe to reconnect.

8. A redundant fire protection system according to claim 1, wherein the first and second groups of fire protection related detectors comprise one or more fire detectors.

9. A redundant fire protection system according to claim 1, wherein the first and second groups of fire protection related detectors comprise one or more smoke detectors.

10. A redundant fire protection system according to claim 1, wherein the power supply network comprises a first and a second supply path.

11. A redundant fire protection system according to claim 1, wherein the data communication network comprises a first and a second communication path.

12. A redundant fire protection system according to claim 1, further comprising a redundant current detection arrangement being operatively connected to the fire protection control unit.

13. A redundant fire protection system according to claim 1, further comprising a controllable fire suppression arrangement operatively connected to the fire protection control unit, wherein the controllable fire suppression arrangement comprises one or more units arranged for dispersing one or more of the following: water, powder, foam, and inert gasses.

14. A system, comprising:
a wind turbine; and
a fire redundant protection system operably connected to the wind turbine and adapted to feed power into an associated power supply grid, the redundant fire protection system comprising:
a fire protection control unit,
a first group of fire protection related detectors adapted to monitor a first wind turbine component, and
a second group of fire protection related detectors adapted to monitor the first wind turbine component,
wherein the fire protection control unit is operatively connected to the first and second groups of fire protection related detectors via a redundant power supply and data communication network.

15. A method for fire protecting a wind turbine adapted to feed power into an associated power supply grid, the method comprising:
providing a first group of fire protection related detectors for monitoring a first wind turbine component,
providing a second group of fire protection related detectors for monitoring the first wind turbine component, and
performing a predetermined protection act if a detector of the first and/or the second group of fire protection related detectors detects an abnormal working condition.

16. A method according to claim 15, wherein the predetermined protection act comprises tripping a switch gear so as to disconnect the wind turbine from an associated power supply grid.

17. A method according to claim 15, wherein the predetermined protection act comprises activating a controllable fire suppression arrangement operatively connected to the fire protection control unit, wherein the controllable fire suppression arrangement comprises one or more units arranged for dispersing one or more of the following: water, powder, foam, and inert gasses.
